(19) United States
(12) Patent Application Publication
(10) Pub. No.: US 2026/0156455 A1
(43) Pub. Date: Jun. 4, 2026

(54) TECHNIQUES TO CLEANUP DISCOVERY SERVICE EVENT RECORDS

(71) Applicant: Apple Inc., Cupertino, CA (US)

(72) Inventors: Jean-Marc PADOVA, San Francisco, CA (US); Avinash NARASIMHAN, Fremont, CA (US); He ZHENG, Irvine, CA (US); Hyewon LEE, Cupertino, CA (US); Raj S. CHAUGULE, Santa Clara, CA (US)

(21) Appl. No.: 19/360,198

(22) Filed: Oct. 16, 2025

Related U.S. Application Data
(60) Provisional application No. 63/726,940, filed on Dec. 2, 2024.
(60) Provisional application No. 63/738,413, filed on Dec. 23, 2024.

(51) Int. Cl. H04W 8/20

(52) U.S. Cl. CPC H04W 8/20

(57) ABSTRACT

The described embodiments relate to wireless communications, including methods and apparatus for managing event records on a discovery service server by a wireless device. A local profile assistant (LPA) of the wireless device can request cancelation of one or more events and/or deletion of one or more event records on the discovery service server for one or more pending events for one or more reasons, such as when a pending event was previously processed by the wireless device, when a pending event is unsupported by the wireless device, and/or when a user rejects a pending event.

### CROSS-REFERENCE TO RELATED APPLICATIONS

The present application claims the benefit of U.S. Provisional Application No. 63/738,413, entitled “TECHNIQUES TO CLEANUP DISCOVERY SERVICE EVENT RECORDS,” filed Dec. 23, 2024 and U.S. Provisional Application No. 63/726,940, entitled “TECHNIQUES TO CLEANUP DISCOVERY SERVICE EVENT RECORDS,” filed Dec. 2, 2024, the contents of all of which are incorporated by reference herein in their entirety for all purposes.

### FIELD

The described embodiments relate to wireless communications, including methods and apparatus for managing event records on a discovery service server by a wireless device. A local profile assistant (LPA) of the wireless device can request cancelation of one or more events and/or deletion of one or more event records on the discovery service server for one or more pending events for one or more reasons, such as when a pending event was previously processed by the wireless device, when a pending event is unsupported by the wireless device, and/or when a user rejects a pending event.

### BACKGROUND

Newer generation, fifth generation (5G), cellular wireless networks that implement one or more 3^{rd} Generation Partnership Project (3GPP) standards are rapidly being developed and deployed by mobile network operators (MNOs) worldwide. In addition, sixth generation (6G) standards are in active development. The newer cellular wireless networks provide a range of packet-based services, with 5G (and 6G) technology providing increased data throughput and lower latency connections that promise enhanced mobile broadband services for 5G-capable (and 6G-capable) wireless devices. Access to cellular services provided by an MNO can require use to cellular credentials and/or secure processing provided by a secure element (SE), such as a universal integrated circuit card (UICC), an embedded UICC (eUICC), or an integrated UICC (iUICC) included in the wireless device.

Typically, wireless devices have been configured to use removable UICCs, that include at least a microprocessor and a read-only memory (ROM), where the ROM is configured to store an MNO profile, also referred to as subscriber identity module (SIM) or SIM profile, which the wireless device can use to register and interact with an MNO to obtain wireless services via a cellular wireless network. The SIM profile hosts subscriber data, such as a digital identity and one or more cryptographic keys, to allow the wireless device to communicate with a cellular wireless network. Typically, a UICC takes the form of a small removable card, commonly referred to as a SIM card or physical SIM (pSIM) card, which can be inserted into a UICC-receiving bay of a mobile wireless device. In more recent implementations, UICCs are being embedded directly into system boards of wireless devices as eUICCs or integrated with other system components as iUICCs, which can provide advantages over traditional, removable UICCs. The eUICCs and/or iUICCs can include a rewritable memory that can facilitate installation, modification, and/or deletion of one or more electronic SIMs (eSIMs) on the eUICC/iUICC, where the eSIMs can provide for new and/or different services and/or updates for accessing extended features provided by MNOs. An eUICC/iUICC can store a number of MNO profiles—also referred to herein as eSIMs—and can eliminate the need to include UICC-receiving bays in wireless devices. The use of multiple SIMs and/or eSIMs is expected to offer flexibility for access to multiple services of multiple wireless networks.

A wireless device can obtain and update eSIM profiles from one or more MNO provisioning servers where notifications regarding availability of an eSIM profile or remote profile management (RPM) update to an eSIM of the wireless device can be provided via a discovery service server. Event records at the discovery service server for orphaned, unsupported, or user rejected events can lead to a poor user experience. Techniques are needed to enable the wireless device to manage event records associated with events for the wireless device maintained by the discovery service server.

### SUMMARY

The described embodiments relate to wireless communications, including methods and apparatus to manage event records (also referred to as events) maintained at a discovery service server for a wireless device. Exemplary events include download of an electronic subscriber identity module (eSIM) profile for the wireless device and a remote profile management (RPM) procedure to manage one or more eSIM profiles of the wireless device. In some circumstances, an event record can remain on the discovery service server after successful completion by the wireless device of the event associated with the event record, e.g., a delete event message from a mobile network operator (MNO) provisioning server to the discovery service server may be not received or processed by the discovery service server, resulting in an orphaned event record at the discovery service server. The wireless device can obtain indication of the event record that continues to be pending at the discovery service server, e.g., via a push, pull, periodic, and/or manual check for events by the wireless device. For an event that has been previously completed successfully, the wireless device can provide a cancelation message to the discovery service server indicating rejection of the event, where the cancelation message includes a reason for rejection of the event, such as a duplicate identifier value indicating a duplicate event. In some embodiments, an event can be unsupported by capabilities and/or configuration of the wireless device. The wireless device can provide to the discovery service server a cancelation message that indicates rejection of the event with an unsupported event type identifier indicating that the wireless device does not support execution of the event pending for the wireless device. In some embodiments, a user of the wireless device can reject execution of an event pending for the wireless device. The wireless device can provide to the discovery service server a cancelation message that indicates rejection of the event with a user rejection indication as a reason for rejection of the event pending for the wireless device. In some embodiments, a cancelation message from the wireless device to the discovery service server includes a reason for rejection of an event pending for the wireless device. In some embodiments, the cancelation message form the wireless device to the discovery service server includes reasons for rejection of multiple events pending for the wireless device. In some embodiments, the discovery service server deletes one or more event records responsive to receipt of the cancelation message from the wireless device. In some embodiments, the discovery service server provides a deletion message to the MNO provisioning server indicating deletion of the one or more event records from the discovery service server. In some embodiments, the deletion message includes one or more identifiers indicating one or more reasons for deletion of the one or more event records from the discovery service server. In some embodiments, one or more identifiers indicating the one or more reasons for deletion of the one or more event records is based on corresponding one or more identifiers included in the cancelation message obtained by the discovery service server from the wireless device. In some embodiments, the discovery service server is a subscription manager discovery server (SM-DS). In some embodiments, the MNO provisioning server is a subscription manager data preparation plus (SM-DP+) server.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to adapt communication parameters for a wireless device, according to some embodiments.

FIG. 2 illustrates a block diagram of a more detailed view of exemplary components of a wireless device of the system of FIG. 1, according to some embodiments.

FIG. 3 illustrates a block diagram of an exemplary system for remote profile management (RPM) of electronic subscriber identity module (eSIM) profiles of a wireless device, according to some embodiments.

FIGS. 4A and 4B illustrate flow diagrams of an example of a download event cleanup failure at a discovery service server, according to some embodiments.

FIG. 4C illustrates a flow diagram of an example of a download event cleanup procedure to delete a stale download event maintained by a discovery service server, according to some embodiments.

FIGS. 5A and 5B illustrate flow diagrams of an example of event cleanup at a discovery service server to delete an event unsupported by the wireless device, according to some embodiments.

FIG. 5C illustrates a flow diagram of an example of event cleanup at a discovery service server for an RPM event rejected by a user of a wireless device, according to some embodiments.

FIG. 5D illustrates a flow diagram of an example of event cleanup at a discovery service server for a download event rejected by a user of a wireless device, according to some embodiments.

FIG. 6A illustrates a flow chart of an exemplary method to manage event records maintained by a discovery service server by one or more components of a wireless device, according to some embodiments.

FIG. 6B illustrates a flow chart of an exemplary method to management events records maintained by a discovery service server by one or more component of the discovery service center, according to some embodiments.

FIG. 7 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

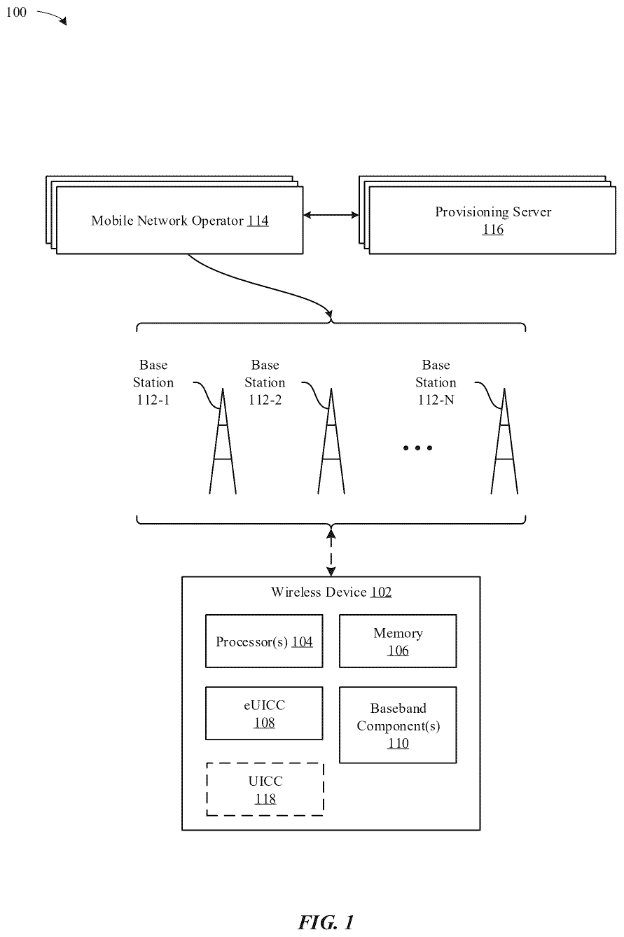

These and other embodiments are discussed below with reference to FIGS. 1 through 7; however, those skilled in the art will readily appreciate that the detailed description given herein with respect to these figures is for explanatory purposes only and should not be construed as limiting.

FIG. 1 illustrates a block diagram of different components of a system 100 that includes i) a wireless device 102, which can also be referred to as a mobile wireless device, a cellular wireless device, a wireless communication device, a mobile device, a user equipment (UE), a device, a primary wireless device, a secondary wireless device, an accessory wireless device, a cellular-capable wearable device, and the like, ii) a group of base stations 112-1 to 112-N, which are managed by different Mobile Network Operators (MNOs) 114, and iii) a set of provisioning servers 116 that are in communication with the MNOs 114. The wireless device 102 can represent a mobile computing device (e.g., a phone, a tablet, a peripheral device, etc.), the base stations 112-1 to 112-N can represent cellular radio access network (RAN) entities including fourth generation (4G) Long Term Evolution (LTE) evolved NodeBs (eNodeBs or eNBs), fifth generation (5G) NodeBs (gNodeBs or gNBs), and/or sixth generation (6G) NodeBs that are configured to communicate with the wireless device 102. Each of the base stations 112-1 to 112-n can be a single entity, quasi-collocated entities, or separated among multiple units (e.g., Central Units (CUs), Distributed Units (DUs), Remote Units (RUs)). The MNOs 114 can represent different wireless service providers that provide specific services (e.g., voice, data, video, messaging) to which a user of the wireless device 102 can subscribe to access the services via the wireless device 102. Applications resident on the wireless device 102 can advantageously access services of a cellular wireless network provided by a wireless service provider using 4G LTE connections, 5G connections, and/or 6G connections (when available) via one or more base stations 112.

As shown in FIG. 1, the wireless device 102 can include processing circuitry, which can include one or more processors 104 and a memory 106, an embedded Universal Integrated Circuit Card (eUICC) 108, and/or integrated UICC (iUICC) (not shown) and baseband component 110 used for transmission and reception of cellular wireless radio frequency signals. In some embodiments, the wireless device 102 can include one or more universal integrated circuit cards (UICCs) 118, also referred to as physical SIM cards, each UICC 118 including a SIM, in addition to or in place of the eUICC 108 providing one or more electronic SIMs (eSIMs) and/or an iUICC providing one or more eSIMs. A wireless device 102 that includes multiple active (enabled) SIMs and/or eSIMs can be referred to generally herein as a multi-SIM/eSIM wireless device. The one or more processors 104 can include one or more wireless processors, such as a cellular baseband component, a wireless local area network processor, a wireless personal area network processor, a near-field communication processor, and one or more system-level application processors. The components of the wireless device 102 work together to enable the wireless device 102 to provide useful features to a user of the wireless device 102, such as cellular wireless network access, non-cellular wireless network access, localized computing, location-based services, and Internet connectivity. Although depicted as distinct blocks, the various components (e.g., memory 106, processor(s) 104, eUICC 108, baseband component 110, and UICC 118) can be arranged and combined in any number of configurations.

The eUICC 108 can be configured to store multiple eSIMs for accessing services offered by one or more different MNOs 114 via communication through base stations 112-1 to 112-N. To be able to access services provided by the MNOs, one or more eSIMs can be provisioned to the eUICC 108 of the wireless device 102. The wireless device 102 can include wireless circuitry, including the baseband component 110 and at least one transmitter/receiver, also referred to as a transceiver to transmit to and receive cellular wireless signals from network access network entities of a cellular wireless network. In some embodiments, the provisioning server 116 can provide an indication to the wireless device 102 via a discovery service server of availability of an eSIM to download to the wireless device 102 or of a remote profile management (RPM) update for an eSIM resident of the eUICC 108 of the wireless device 102.

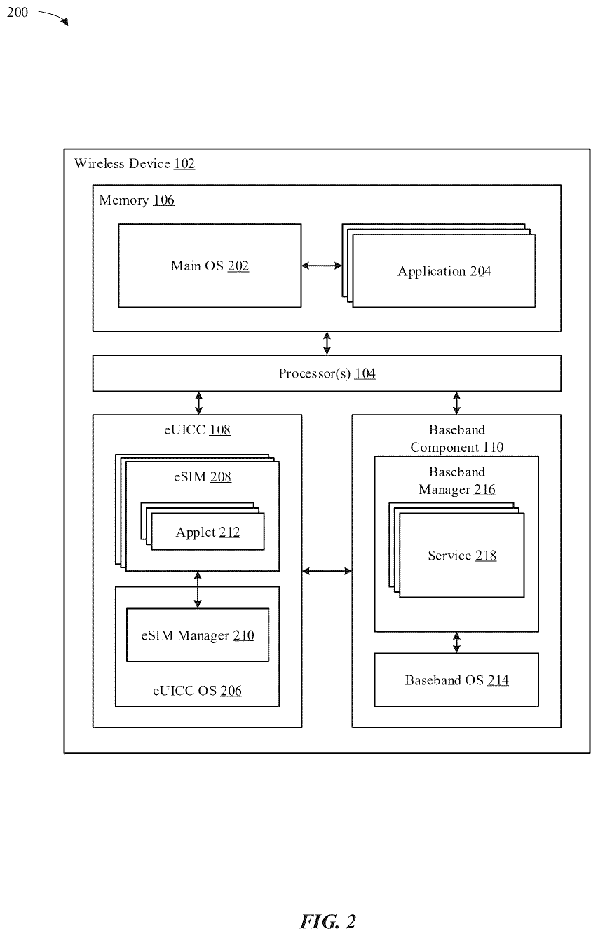

FIG. 2 illustrates a block diagram 200 of a more detailed view of exemplary components of a wireless device 102 of the system 100 of FIG. 1. The one or more processors 104, in conjunction with the memory 106, can implement a main operating system (OS) 202 that is configured to execute applications 204 (e.g., native OS applications and user applications). The one or more processors 104 can include applications processing circuitry and, in some embodiments, wireless communications control circuitry. The applications processing circuitry can monitor application requirements and usage to determine recommendations about communication connection properties, such as bandwidth and/or latency, and provide information to the communications control circuitry to determine suitable wireless connections for use by particular applications. The communications control circuitry can process information from the applications processing circuitry as well as from additional circuitry, such as the baseband component 110, and other sensors (not shown) to determine states of components of the wireless device 102, e.g., reduced power modes, as well as of the wireless device 102 as a whole, e.g., mobility states, activity/inactivity states. The wireless device 102 further includes an eUICC 108 that can be configured to implement an eUICC OS 206 to manage the hardware resources of the eUICC 108 (e.g., a processor and a memory embedded in the eUICC 108). The eUICC OS 206 can also be configured to manage eSIMs 208 that are stored by the eUICC 108, e.g., by enabling, disabling, modifying, updating, or otherwise performing management of the eSIMs 208 within the eUICC 108 and providing the baseband component 110 with access to the eSIMs 208 to provide access to wireless services for the wireless device 102. The eUICC OS 206 can include an eSIM manager 210, which can perform management functions for various eSIMs 208. Each eSIM 208 can include a number of applets 212 that define the manner in which the eSIM 208 operates. For example, one or more of the applets 212, when implemented by the baseband component 110 and the eUICC 108, can be configured to enable the wireless device 102 to communicate with an MNO 114 and provide useful features (e.g., phone calls and internet) to a user of the wireless device 102.

The baseband component 110 of the wireless device 102 can include a baseband OS 214 that is configured to manage hardware resources of the baseband component 110 (e.g., a processor, a memory, different radio components, etc.). The baseband component 110 (or a portion thereof) can also be referred to as a baseband component, a wireless baseband component, a baseband wireless processor, a cellular baseband component, a cellular component, and the like. According to some embodiments, the baseband component 110 can implement a baseband manager 216 that is configured to interface with the eUICC 108 to establish a secure channel with a provisioning server 116 and obtain information (such as eSIM data) from the provisioning server 116 for purposes of managing eSIMs 208. The baseband manager 216 can be configured to implement services 218, which represent a collection of software modules that are instantiated by way of the various applets 212 of enabled eSIMs 208 that are included in the eUICC 108. For example, services 218 can be configured to manage different connections between the wireless device 102 and MNOs 114 according to the different eSIMs 208 that are enabled within the eUICC 108. In some embodiments, a processor 104 of the wireless device 102 and/or the eUICC 108 can include a local profile assistance (LPA) module to assist with management of eSIMs on the eUICC 108 of the wireless device 102.

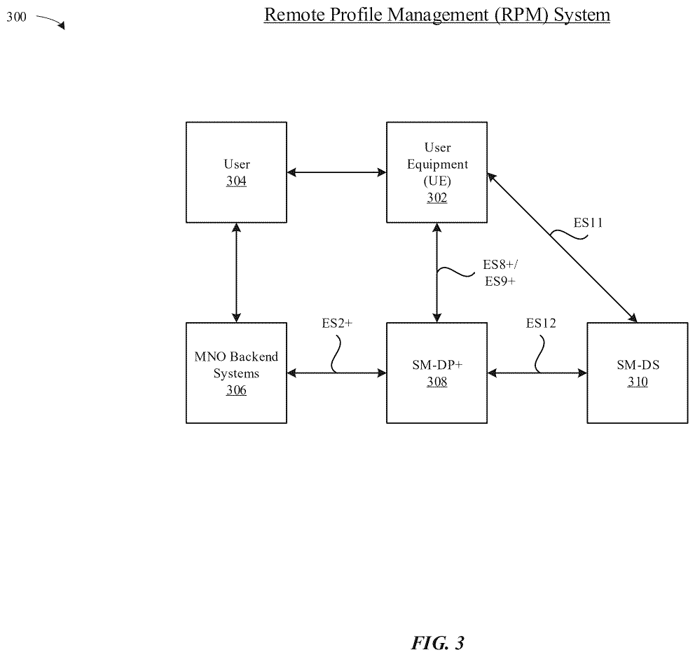

FIG. 3 illustrates a block diagram 300 of an exemplary system for providing remote profile management (RPM) of one or more eSIMs 208 stored on an eUICC 108 of a user equipment (UE) 302. A user 304 of the UE 302 can interact with MNO backend systems 306 associated with an MNO 114 to obtain and/or manage an eSIM 208 for the UE 302, e.g., to subscribe to and/or modify cellular wireless service provided by the MNO 114 via credentials of the eSIM 208. The MNO backend systems 306 can communicate via an ES2+ interface with an MNO provisioning server 116, e.g., a subscription manager data preparation plus (SM-DP+) server 308, to order preparation of an eSIM 208, provide an update to an eSIM 208 for the UE 302, and/or provide other eSIM 208 administrative functions. The SM-DP+ 308 can be connected via an ES12 interface to a subscription manager discovery server (SM-DS) 310 that can be accessed by the UE 302 via an ES11 interface. The SM-DP+ 308 can communicated via the ES12 interface to register event records for the UE 302 at the SM-DS 310. The SM-DP+ 308 can also delete event records for the UE 302 at the SM-DS 310 via messages over the ES12 interface. The SM-DS 310 can aggregate eSIM profile events for the UE 302 for one or more MNOs 114 and provide notification to the UE 302, via the ES11 interface, of availability of one or more eSIM profile events for the eUICC 108 of the UE 302, e.g., via a push notification message to the UE 302, responsive to a pull notification message from the UE 302, where notification can occur periodically at regular intervals and/or manually on demand. The SM-DS 310 can provide information over the ES11 interface via notification messages to the UE 302 regarding an eSIM 208 available to download to the eUICC 108 of the UE 302 and/or an eSIM RPM procedure to be executed for an eSIM 208 on the eUICC 108 of the UE 302. The eUICC 108 of the UE 302 can communicate with the SM-DP+ 308 via an ES8+ interface to manage download an installation of an eSIM 208 profile from the SM-DP+ 308 to the eUICC 108 of the UE 302. An LPA of the UE 302 can also communicate with the SM-DP+ 308 via an ES9+ interface to provide secure transport and management of a bound profile package (BPP) that securely contains an eSIM 208 and/or to provide for RPM procedures for one or more eSIM 208 on the eUICC 108 of the UE 302.

In a normal eSIM 208 download procedure, following successful download and installation of the eSIM 208 on the eUICC 108 of the UE 302, the SM-DP+ 308 sends a delete event message via the ES12 interface to the SM-DS 310 for the event record corresponding to the eSIM 208 download for the eUICC 108 of the UE 302. If the delete event message is not provided by the SM-DP+ 308, lost in transmission from the SM-DP+ 308 to the SM-DS 310, or not processed properly by the SM-DS 310, the event record for the eSIM 208 download can remain on the SM-DS 310 resulting in an orphaned event. Subsequently, the UE 302 can query the SM-DS 310 for pending events and the orphaned event record can cause the UE 302 to be redirected to the SM-DP+ 308 which may not have a matching event for the UE 302, as the eSIM 208 was previously downloaded to the eUICC 108 of the UE 302. The undeleted event can repeatedly generate an error at the UE 302 each time the UE queries the SM-DS 310 until either the SM-DP+ 308 explicitly clears the event record from the SM-DS 310 or the event record expires on the SM-DS 310 and is subsequently deleted. This repeated error at the UE 302 due to the orphaned event record can result in a poor user experience, e.g., repeated error messages for download failures.

In some circumstances, a UE 302 can be configured such that a pending event may not be supported by the UE 302 or execution of the feature corresponding to the pending event may not be enabled at the UE 302. An event record corresponding to the pending event may remain on the SM-DS 310 and a corresponding action/event at the SM-DP+ 308 may also remain unfulfilled. In such cases, a pending event may require repeated rejection or cancelation at the UE 302 until the pending event is deleted by the SM-DP+ 308 and/or expires at the SM-DS 310. Until the pending event record corresponding to the pending event is deleted, repeated error messages for rejected events may occur at the UE 302.

Additionally, for certain events, such as for an eSIM profile download or an eSIM RPM procedure, user consent can be required. Should a user of the UE 302 does not provide consent, a pending event may remain at both the SM-DP+ 308 and at the SM-DS 310. Presently, there is no procedure available for a user of the UE 302 to reject an event and force a cleanup of the pending events at the SM-DP+ 308 and the SM-DS 310. In addition, for reasons of privacy, it can be preferred that the UE 302 cause rejection of the event via communication to the SM-DS 310 and not to the SM-DP+ 308 to limit information provided by the UE 302 to the SM-DP+ 308.

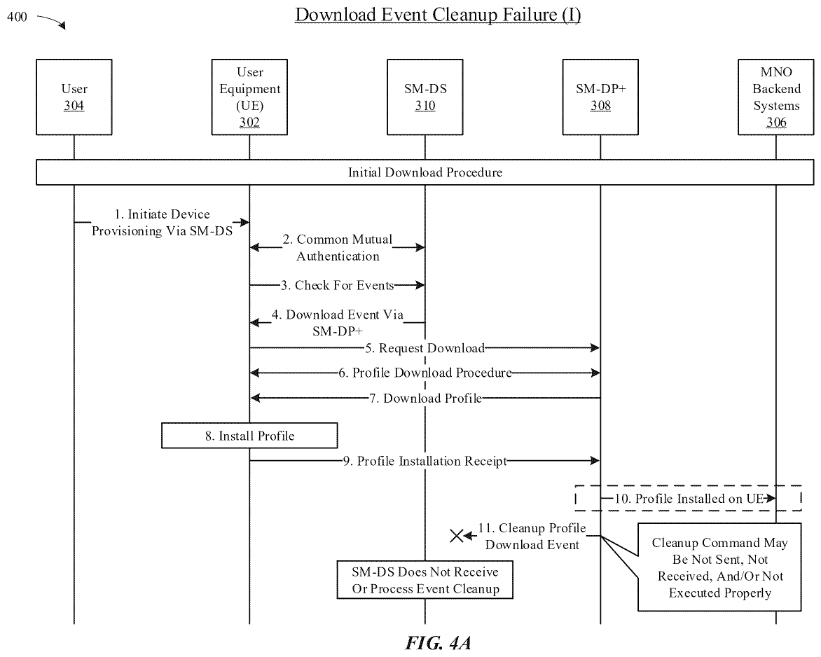

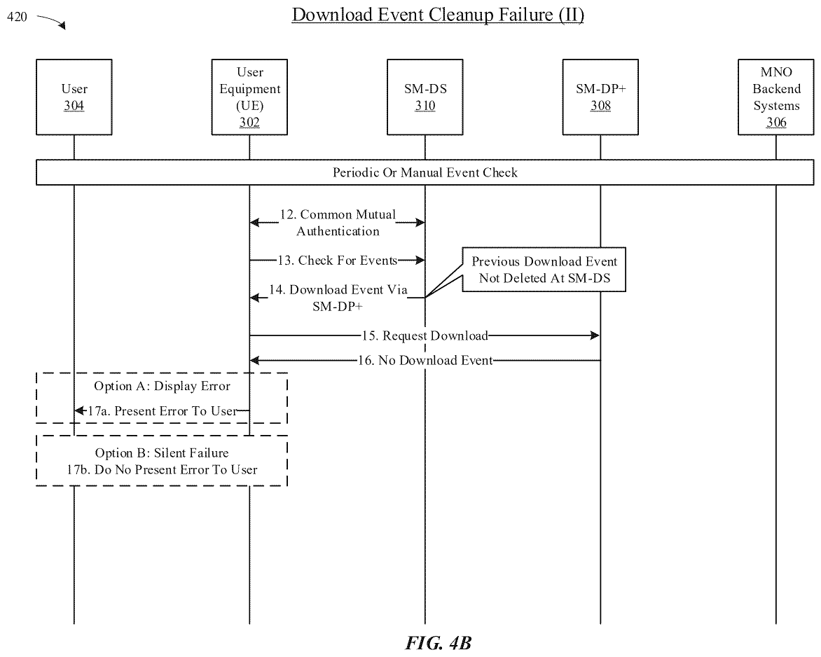

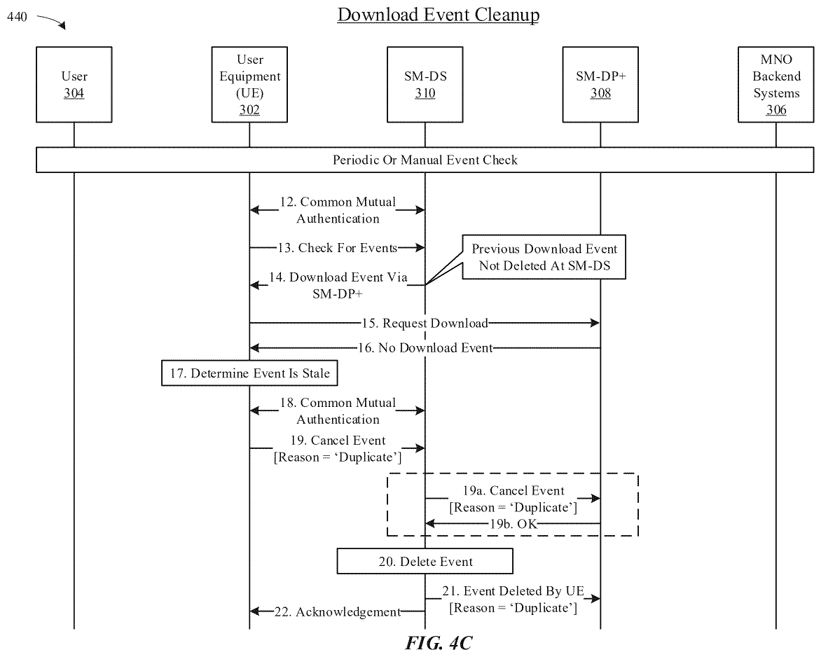

FIGS. 4A and 4B illustrate flow diagrams 400, 420 of an exemplary scenario where a download event for an eSIM 208 installed on an eUICC 108 of a wireless device, e.g., UE 302, remains on a discovery service server, e.g., SM-DS 310. Beginning with flow diagram 400 of FIG. 4A, at step 1, a user 304 of the UE 302 can initiate provisioning of an eSIM 208 to the UE 302. At step 2, the UE 302 performs a common mutual authentication procedure with the SM-DS 310. At step 3, the UE 302 sends a message to the SM-DS 310 to check for one or more event records stored at the SM-DS 310, where an event record indicates a pending event for the UE 302. At step 4, the SM-DS 310 returns to the UE 302 a message indicating a pending download event for the UE 302 via a provisioning server, e.g., SM-DP+ 308. The message from the SM-DS 310 can include information for accessing the SM-DP+ 308 by the UE 302. At step 5, the UE 302 sends a message to the SM-DP+ 308 request download of an eSIM profile 208 associated with the pending download event. At step 6, the UE 302 and SM-DP+ 308 perform actions to initiate an eSIM profile 208 download procedure. At step 7, the SM-DP+ 308 downloads the eSIM profile 208 to the UE 302. At step 8, the UE 302 installs the eSIM profile 208 on the eUICC 108 of the UE 302. At step 9, the UE 302 provides a receipt message to the SM-DP+ indicating successful installation of the eSIM profile 208 on the eUICC 108 of the UE 302. In some embodiments, at step 10, the SM-DP+ optionally provides a message to one or more MNO backend systems 306 that the eSIM profile 208 has been installed on the eUICC 108 of the UE 302. In a normal successful procedure, at step 11, the SM-DP+ 308 would provide a command to the SM-DS 310 to cause the SM-DS 310 to cleanup, e.g., delete, the event record for the eSIM profile 208 download event completed by the UE 302. In an unsuccessful procedure, at step 11, the cleanup command may be not provided by the SM-DP+ 308 to the SM-DS 310, the cleanup command may be sent by the SM-DP+ 308 but not received properly by the SM-DS 310, and/or execution of the cleanup command may not be performed properly at the SM-DS 310. As a result of the cleanup failure, where the SM-DS 310 does not receive or process the cleanup command, the download eSIM profile event record may remain at the SM-DS 310.

Continuing with flow diagram 420 of FIG. 4B, subsequently, the UE 302 can be configured and/or prompted to perform a periodic or manual check for pending events, e.g., based on a push notification, a pull procedure, etc. At step 12, the UE 302 performs a common mutual authentication procedure with the SM-DS 310. At 13, the UE 302 sends a message to the SM-DS 310 to check for one or more pending event records for the UE 302. At step 14, the SM-DS 310 returns to the UE 302 a message indicating the pending download event previously executed but not cleaned up at the SM-DS 310. At step 15, the UE 302 queries the SM-DP+ 308 for the download event indicated pending by the SM-DS 310. As the eSIM profile 208 was previously successfully downloaded to the UE 302, at step 16, the SM-DP+ 308 returns to the UE 302 a message indicating there is no pending download event for the UE 302. In some embodiments, at step 17a, the UE 302 can present an error indication, e.g., via a notification displayed and/or alerted at the UE 302 to the user 304 of the UE 302. In some embodiments, at step 17b, the UE 302 can silently recognize the download event error without displaying an error message to the user 304 of the UE 302. The undeleted eSIM profile download event record can repeatedly generate an error at the UE 302 each time the UE queries the SM-DS 310 until either the SM-DP+ 308 explicitly clears the event record from the SM-DS 310 or the event record expires on the SM-DS 310 and is subsequently deleted. This repeated error at the UE 302 due to the orphaned event record can result in a poor user experience, e.g., repeated error messages for download event failures.

FIG. 4C illustrates a flow diagram 440 of an example of a download event cleanup procedure to delete a stale download event record from a discovery service server, e.g., from SM-DS 310. The UE 302 can be configured and/or prompted to perform a periodic or manual check for pending events, e.g., based on a push notification, a pull procedure, etc. At step 12, the UE 302 performs a common mutual authentication procedure with the SM-DS 310. In some embodiments, as part of the mutual authentication procedure, the UE 302 indicates to the SM-DS 310 that the UE 302 supports verification of response messages from the SM-DS 310. In some embodiments, as part of the mutual authentication procedure, the SM-DS 310 indicates support for event deletion initiated by the UE 302, e.g., by a local profile assistant (LPA) on a processor 104 or on the eUICC 108 of the UE 302. At step 13, the UE 302 sends a message to the SM-DS 310 to check for one or more pending event records for the UE 302. At step 14, the SM-DS 310 returns to the UE 302 a message indicating the pending download event previously executed but not cleaned up at the SM-DS 310. At step 15, the UE 302 queries the SM-DP+ 308 for the download event indicated pending by the SM-DS 310. As the eSIM profile 208 was previously successfully downloaded to the UE 302, at step 16, the SM-DP+ 308 returns to the UE 302 a message indicating there is no pending download event for the UE 302. At step 17, the UE 302 can recognize that the pending event indicated by the SM-DS 310 can be stale, e.g., duplicative of a download event previously performed successfully by the UE 302. In some embodiments, the event record includes a unique event identifier (ID) value that the UE 302 can use to identify that the event has been performed by the UE 302. At step 18, the UE 302 can perform a second common mutual authentication procedure with the SM-DS 310. At step 19, the UE 302 can provide a cancelation message to the SM-DS 310 requesting cancelation of the event associated with the event record that has already been performed previously by the UE 302. In some embodiments, the cancelation message includes an event ID value indicating the event record. In some embodiments, the cancelation message includes a reason value, e.g., a duplicate identifier, indicating that the event record should be deleted as the event is duplicative to a previously performed and successfully completed download event for an eSIM profile 208. In some embodiments, the cancelation message includes a hash of the event ID and/or a hash of the reason value (or a hash of both the event ID and the reason value) to protect the contents of the cancelation message. In some embodiments, the cancelation message includes a digital signature of the eUICC 108 contained in the UE 302 as a protection mechanism for the cancelation message. At step 19a, optionally, the SM-DS 310 can request confirmation with the SM-DP+ 308 regarding deleting the event record for the download eSIM profile event of the UE 302. In some embodiments, the confirmation request can include the cancel event request message received from the UE 302, e.g., the cancelation message received at step 19. In some embodiments, the confirmation request includes an identifier of the eUICC 108 included in the UE 302, e.g., an EID value of the eUICC 108. At step 19b, the SM-DP+ 308 can approve deletion of the event record for the download eSIM profile event of the UE 302. At step 20, the SM-DS 310 deletes the event record for the download eSIM profile event of the UE 302. At step 21, the SM-DS 310 can send to the SM-DP+ 308 a message indicating that the event record for the download eSIM profile event of the UE 302 has been deleted at the SM-DS 310. In some embodiments, the message includes a reason value, e.g., a duplicate identifier, indicating that the event record should be deleted as the event is duplicative to a previously performed and successfully completed download event for an eSIM profile 208. At step 22, the SM-DS 310 can provide an acknowledgement message to the UE 302 confirming receipt and/or completion of the requested event record deletion.

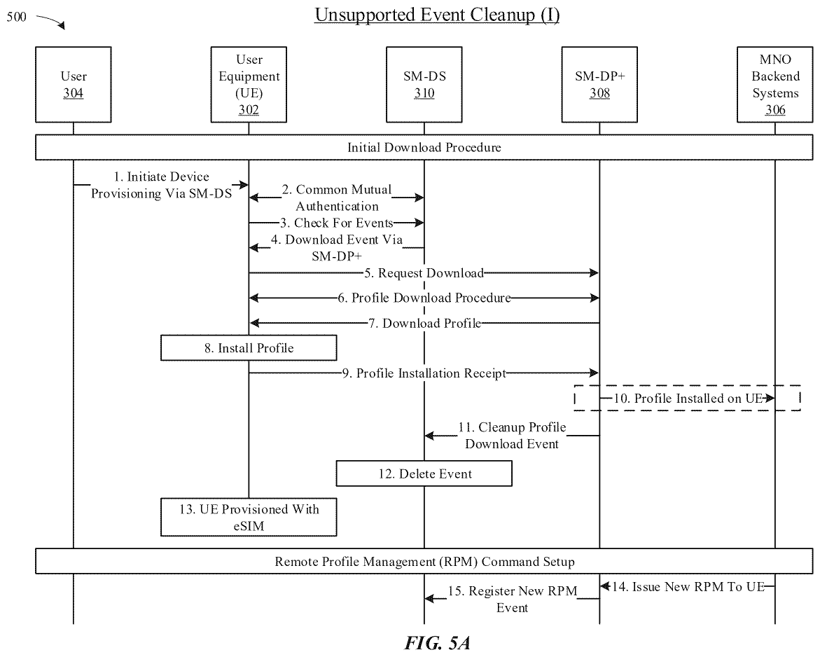

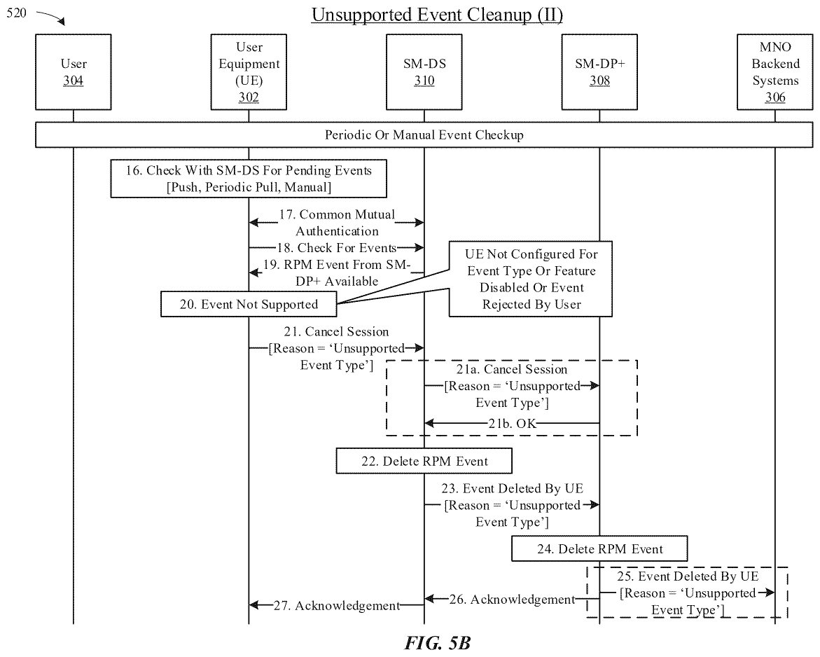

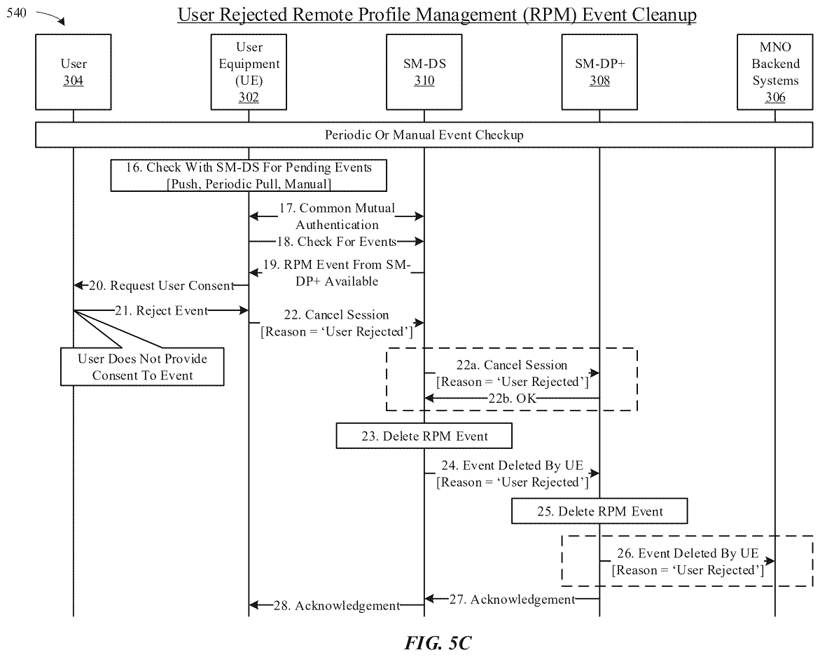

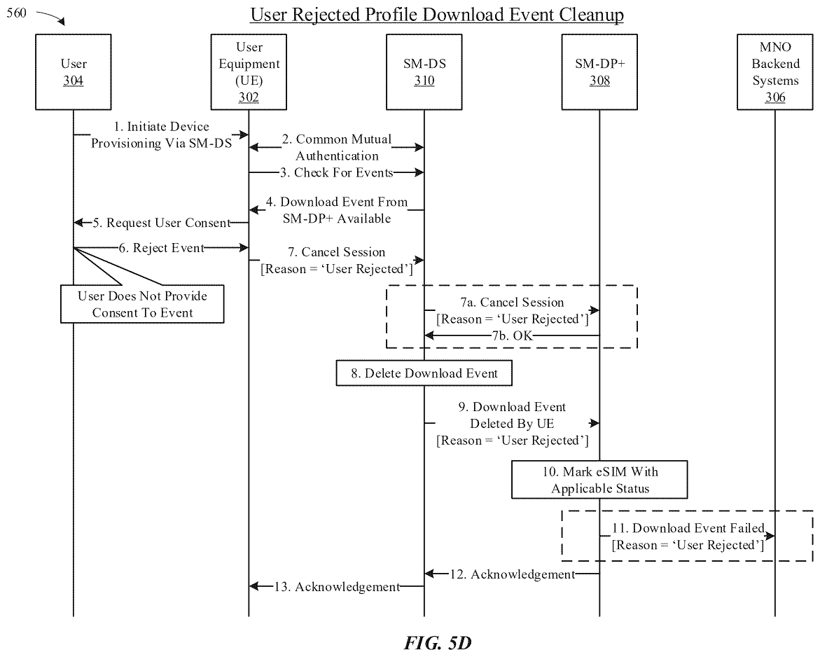

FIGS. 5A and 5B illustrate flow diagrams 500, 520 of an example of event cleanup at a discovery service server, e.g., SM-DS 310, to delete an event record for an event unsupported by the UE 302. Beginning with the flow diagram 500 of FIG. 5A, the UE 302 successfully performs a download eSIM profile 208 event. At step 1, a user 304 of the UE 302 can initiate provisioning of an eSIM 208 to the UE 302. At step 2, the UE 302 performs a common mutual authentication procedure with the SM-DS 310. At step 3, the UE 302 sends a message to the SM-DS 310 to check for one or more event records stored at the SM-DS 310, where an event record indicates a pending event for the UE 302. At step 4, the SM-DS 310 returns to the UE 302 a message indicating a pending download event for the UE 302 via a provisioning server, e.g., SM-DP+ 308. The message from the SM-DS 310 can include information for accessing the SM-DP+ 308 by the UE 302. At step 5, the UE 302 sends a message to the SM-DP+ 308 request download of an eSIM profile 208 associated with the pending download event. At step 6, the UE 302 and SM-DP+ 308 perform actions to initiate an eSIM profile 208 download procedure. At step 7, the SM-DP+ 308 downloads the eSIM profile 208 to the UE 302. At step 8, the UE 302 installs the eSIM profile 208 on the eUICC 108 of the UE 302. At step 9, the UE 302 provides a receipt message to the SM-DP+ indicating successful installation of the eSIM profile 208 on the eUICC 108 of the UE 302. In some embodiments, at step 10, the SM-DP+ optionally provides a message to one or more MNO backend systems 306 that the eSIM profile 208 has been installed on the eUICC 108 of the UE 302. At step 11, the SM-DP+ 308 provides a cleanup eSIM profile download event command to the SM-DS 310 to cause the SM-DS 310 to cleanup, e.g., delete, the event record for the eSIM profile 208 download event completed by the UE 302. At step 12, the SM-DS 310 deletes the event record associated with the SIM profile 208 download event responsive to the command from the SM-DP_308. At step 13, the UE 302 has been successfully provisioned with the eSIM profile 208.

Following the initial download procedure, the MNO can set up a remote profile management (RPM) event for the UE 302. The RPM event can be for the eSIM profile 208 previously provisioned to the UE 302. At step 14, an MNO backend system 306 can send a command to the SM-DP+ 308 to issue a new RPM event for the UE 302. Exemplary RPM events can include management, updating, replacement, removal, modification, etc. of an eSIM profile 208 installed on the eUICC 108 of the UE 302. At step 15, the SM-DP+ 308 sends a message to the SM-DS 310 to register a new RPM event for the UE 302.

Following the RPM command setup illustrated by diagram 500 of FIG. 5A, the UE 302, as illustrated in diagram 520 of FIG. 5B, can be configured and/or prompted to perform a periodic or manual check for pending events, e.g., based on a push notification, a pull procedure, etc. At step 16, the UE 302 can check with the SM-DS 310 for pending events for the UE 302. At step 17, the UE 302 performs a common mutual authentication procedure with the SM-DS 310. In some embodiments, as part of the mutual authentication procedure, the UE 302 indicates to the SM-DS 310 that the UE 302 supports verification of response messages from the SM-DS 310. In some embodiments, as part of the mutual authentication procedure, the SM-DS 310 indicates support for event deletion initiated by the UE 302, e.g., by a local profile assistant (LPA) on a processor 104 or on the eUICC 108 of the UE 302. At step 18, the UE 302 sends a message to the SM-DS 310 to check for one or more pending event records for the UE 302. At step 19, the SM-DS 310 provides a response message to the UE 302, where the response message indicates an RPM event is available for the UE 302 via the SM-DP+ 308. In some embodiments, the UE 302 can be configured to not support the RPM event indicated as available for the UE 302. In some embodiments, a feature associated with the RPM event can be disabled at the UE 302 (e.g., turned off by user configuration and/or automatic configuration). In some embodiments, a user 304 of the UE 302 can reject the RPM event for the UE 302. At step 20, the UE 302 can recognize for one or more reasons as described that the RPM event is not supported by the UE 302. At step 21, the UE 302 provides to the SM-DS 310 a cancelation message that requests cancelation of the current session, where the cancelation message includes a reason identifier value, e.g., an unsupported event type value indicating that the pending event is not supported by the UE 302. In some embodiments, the cancelation message includes an event ID value indicating the event record. In some embodiments, the cancelation message includes a hash of the event ID and/or a hash of the reason value (or a hash of both the event ID and the reason value) to protect the contents of the cancelation message. In some embodiments, the cancelation message includes a digital signature of the eUICC 108 contained in the UE 302 as a protection mechanism for the cancelation message. At step 21a, optionally, the SM-DS 310 can request confirmation with the SM-DP+ 308 regarding deleting the event record for the RPM event pending for the UE 302. In some embodiments, the confirmation request can include the cancel session message received from the UE 302, e.g., the cancelation message received at step 21. In some embodiments, the confirmation request includes an identifier of the eUICC 108 included in the UE 302, e.g., an EID value of the eUICC 108. At step 21b, the SM-DP+ 308 can approve deletion of the event record for the RPM event pending for the UE 302. At step 22, the SM-DS 310 can delete the event record associated with the RPM event responsive to receipt from the UE 302 of the cancelation message that indicated the unsupported event type reason. At step 23, the SM-DS 310 can send a message to the SM-DP+ 308 indicating that the event record associated with the RPM event has been deleted at the SM-DS 310 based on a deletion/cancelation request from the UE 302. In some embodiments, the message to the SM-DP+ 308 from the SM-DS 310 can include a reason identifier value, e.g., an unsupported event type reason using the same or an equivalent reason identifier value as received from the UE 302 by the SM-DS 310. At step 24, the SM-DP+ 308 can delete the unsupported RPM event for the UE 302. In some embodiments, at step 25, the SM-DP+ 308 can optionally send a message to one or more MNO backend systems 306 indicating that the issued RPM event for the UE 302 has been deleted based on a deletion/cancelation request from the UE 302. In some embodiments, the message to the MNO backend systems can include a reason identifier value, e.g., an unsupported event type reason using the same or an equivalent reason identifier value as received from the SM-DS 310 by the SM-DP+ 308. At step 26, the SM-DP+ 308 provides an acknowledgement message to the SM-DS 310. At step 27, the SM-DS 310 provides an acknowledgement message to the UE 302.

FIG. 5C illustrates a flow diagram 540 for an event cleanup where a user 304 of a UE 302 rejects an event, e.g., an RPM event for an eSIM profile 208 previously provisioned to the UE 302, such as in FIG. 5A. Following the RPM command setup illustrated in diagram 500 of FIG. 5A, subsequently according to the flow diagram 540 of FIG. 5C, the UE 302 can be configured and/or prompted to perform a periodic or manual check for pending events, e.g., based on a push notification, a pull procedure, etc. At step 16, the UE 302 can check with the SM-DS 310 for pending events for the UE 302. At step 17, the UE 302 performs a common mutual authentication procedure with the SM-DS 310. In some embodiments, as part of the mutual authentication procedure, the UE 302 indicates to the SM-DS 310 that the UE 302 supports verification of response messages from the SM-DS 310. In some embodiments, as part of the mutual authentication procedure, the SM-DS 310 indicates support for event deletion initiated by the UE 302, e.g., by a local profile assistant (LPA) on a processor 104 or on the eUICC 108 of the UE 302. At step 18, the UE 302 sends a message to the SM-DS 310 to check for one or more pending event records for the UE 302. At step 19, the SM-DS 310 provides a response message to the UE 302, where the response message indicates an RPM event is available for the UE 302 via the SM-DP+ 308. In some embodiments, eSIM profile 208 download events and/or eSIM profile 208 RPM events can require user consent prior to execution at the UE 302. At step 20, the UE 302 can request consent from the user 304 of the UE 302 for execution of the RPM event. At step 21, the user 304 can reject execution of the RPM event. At step 22, the UE 302 provides to the SM-DS 310 a cancelation message that requests cancelation of the current session, where the cancelation message includes a reason identifier value, e.g., a user rejected type value indicating that the user 304 of the UE 302 has rejected execution of the RPM event by the UE 302. In some embodiments, the cancelation message includes an event ID value indicating the event record. In some embodiments, the cancelation message includes a hash of the event ID and/or a hash of the reason value (or a hash of both the event ID and the reason value) to protect the contents of the cancelation message. In some embodiments, the cancelation message includes a digital signature of the eUICC 108 contained in the UE 302 as a protection mechanism for the cancelation message. At step 22a, optionally, the SM-DS 310 can request confirmation with the SM-DP+ 308 regarding deleting the event record for the RPM event pending for the UE 302. In some embodiments, the confirmation request can include the cancel session message received from the UE 302, e.g., the cancelation message received at step 22. In some embodiments, the confirmation request includes an identifier of the eUICC 108 included in the UE 302, e.g., an EID value of the eUICC 108. At step 22b, the SM-DP+ 308 can approve deletion of the event record for the RPM event pending for the UE 302. At step 23, the SM-DS 310 can delete the event record associated with the RPM event responsive to receipt from the UE 302 of the cancelation message that indicated the user rejected type reason. At step 24, the SM-DS 310 can send a message to the SM-DP+ 308 indicating that the event record associated with the user rejected RPM event has been deleted at the SM-DS 310 based on a deletion/cancelation request from the UE 302. In some embodiments, the message to the SM-DP+ 308 from the SM-DS 310 can include a reason identifier value, e.g., a user rejected type reason using the same or an equivalent reason identifier value as received from the UE 302 by the SM-DS 310. At step 25, the SM-DP+ 308 can delete the user rejected RPM event for the UE 302. In some embodiments, at step 26, the SM-DP+ 308 can optionally send a message to one or more MNO backend systems 306 indicating that the issued RPM event for the UE 302 has been deleted based on a deletion/cancelation request from the UE 302. In some embodiments, the message to the MNO backend systems can include a reason identifier value, e.g., a user rejected type reason using the same or an equivalent reason identifier value as received from the SM-DS 310 by the SM-DP+ 308. At step 27, the SM-DP+ 308 provides an acknowledgement message to the SM-DS 310. At step 28, the SM-DS 310 provides an acknowledgement message to the UE 302.

FIG. 5D illustrates a flow diagram 560 for an event cleanup where a user 304 of a UE 302 rejects a download event for an eSIM profile 208 available to the UE 302. At step 1, a user 304 of the UE 302 can initiate provisioning of an eSIM 208 to the UE 302. At step 2, the UE 302 performs a common mutual authentication procedure with the SM-DS 310. In some embodiments, as part of the mutual authentication procedure, the UE 302 indicates to the SM-DS 310 that the UE 302 supports verification of response messages from the SM-DS 310. In some embodiments, as part of the mutual authentication procedure, the SM-DS 310 indicates support for event deletion initiated by the UE 302, e.g., by a local profile assistant (LPA) on a processor 104 or on the eUICC 108 of the UE 302. At step 3, the UE 302 sends a message to the SM-DS 310 to check for one or more event records stored at the SM-DS 310, where an event record indicates a pending event for the UE 302. At step 4, the SM-DS 310 returns to the UE 302 a message indicating a pending download event for the UE 302 via a provisioning server, e.g., SM-DP+ 308. The message from the SM-DS 310 can include information for accessing the SM-DP+ 308 by the UE 302. In some embodiments, eSIM profile 208 download events and/or eSIM profile 208 RPM events can require user consent prior to execution at the UE 302. At step 5, the UE 302 can request consent from the user 304 of the UE 302 for execution of the download event. At step 6, the user 304 can reject execution of the download event. At step 7, the UE 302 provides to the SM-DS 310 a cancelation message that requests cancelation of the current session, where the cancelation message includes a reason identifier value, e.g., a user rejected type value indicating that the user 304 of the UE 302 has rejected execution of the download event by the UE 302. In some embodiments, the cancelation message includes an event ID value indicating the event record for the download event. In some embodiments, the cancelation message includes a hash of the event ID and/or a hash of the reason value (or a hash of both the event ID and the reason value) to protect the contents of the cancelation message. In some embodiments, the cancelation message includes a digital signature of the eUICC 108 contained in the UE 302 as a protection mechanism for the cancelation message. At step 7a, optionally, the SM-DS 310 can request confirmation with the SM-DP+ 308 regarding deleting the event record for the download event pending for the UE 302. In some embodiments, the confirmation request can include the cancel session message received from the UE 302, e.g., the cancelation message received at step 7. In some embodiments, the confirmation request includes an identifier of the eUICC 108 included in the UE 302, e.g., an EID value of the eUICC 108. At step 7b, the SM-DP+ 308 can approve deletion of the event record for the download event pending for the UE 302. At step 8, the SM-DS 310 can delete the event record associated with the download event responsive to receipt from the UE 302 of the cancelation message that indicated the user rejected type reason. At step 9, the SM-DS 310 can send a message to the SM-DP+ 308 indicating that the event record associated with the user rejected download event has been deleted at the SM-DS 310 based on a cancelation request from the UE 302. In some embodiments, the message to the SM-DP+ 308 from the SM-DS 310 can include a reason identifier value, e.g., a user rejected type reason using the same or an equivalent reason identifier value as received from the UE 302 by the SM-DS 310. At step 10, the SM-DP+ 308 can mark the eSIM profile 208 associated with the user rejected download event with an applicable status identifier value. In some embodiments, at step 11, the SM-DP+ 308 can optionally send a message to one or more MNO backend systems 306 indicating that a download event for the UE 302 has failed based on a cancelation request from the UE 302. In some embodiments, the message to the MNO backend systems can include a reason identifier value, e.g., a user rejected type reason using the same or an equivalent reason identifier value as received from the SM-DS 310 by the SM-DP+ 308. At step 12, the SM-DP+ 308 provides an acknowledgement message to the SM-DS 310. At step 13, the SM-DS 310 provides an acknowledgement message to the UE 302.

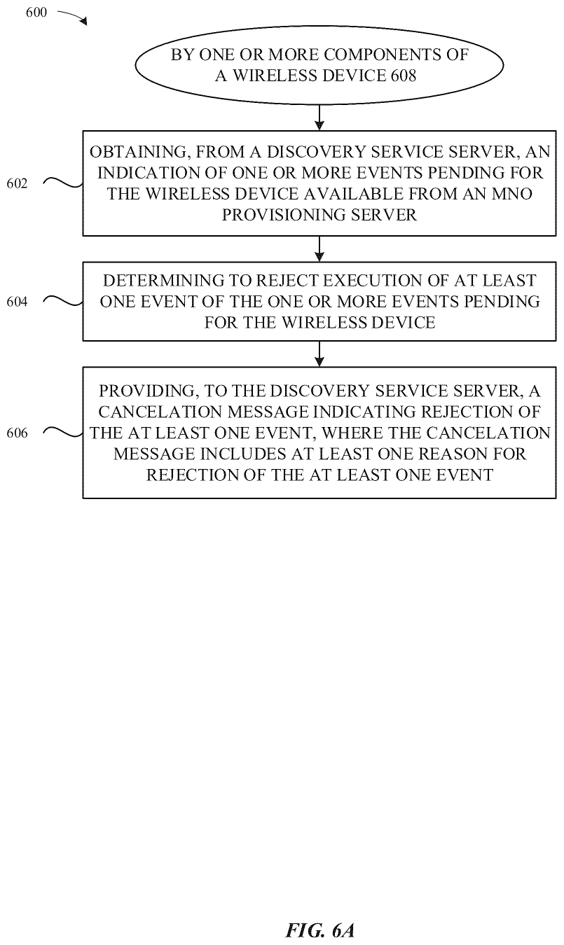

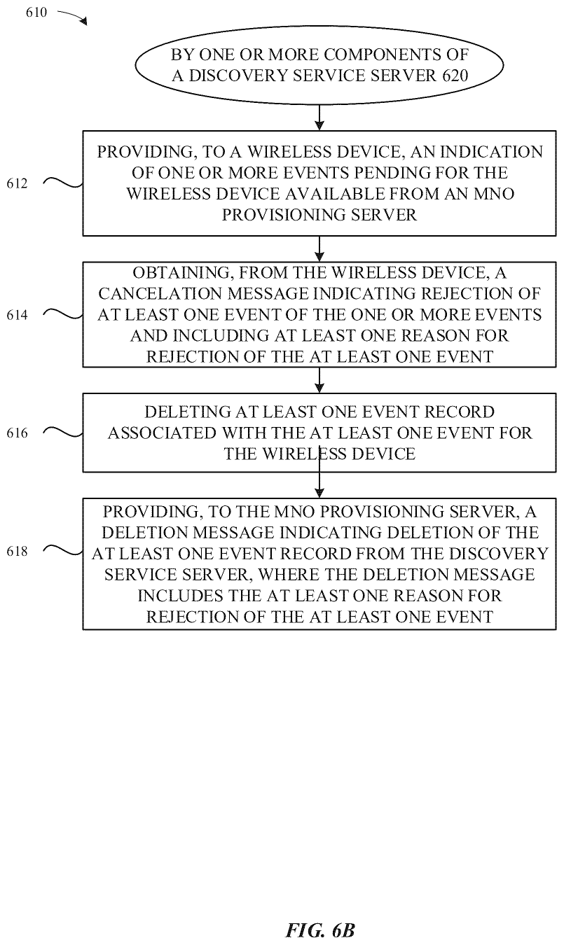

FIG. 6A illustrates a flow chart 600 of a representative method to manage event records of a discovery service server by one or more components of a wireless device 608. In some embodiments, the wireless device 608 can include one or more components and/or combinations of components of the wireless device 102. At 602, the method includes obtaining, from the discovery service server, e.g., from an SM-DS 310, an indication of one or more events pending for the wireless device 608 available from an MNO provisioning server 116, e.g., from an SM-DP+ 310. At 604, the method further includes determining to reject execution at least one event of the one or more events pending for the wireless device 608. At 606, the method further includes providing, to the discovery service server, a cancelation message indicating rejection of the at least one event, where the cancelation message includes at least one reason for rejection of the at least one event.

In some embodiments, the at least one event includes an eSIM profile download. In some embodiments, the at least one event includes an RPM procedure for an eSIM profile 208 of the wireless device 608. In some embodiments, the at least one event includes an eSIM profile download, and the at least one reason for rejection of the at least one event includes a duplicate identifier indicating the eSIM profile 208 was previously downloaded to the wireless device 608 from the MNO provisioning server 116. In some embodiments, the method further includes: i) requesting user consent to the at least one event pending for the wireless device 102, and ii) obtaining user rejection of the at least one event, where the at least one reason for rejection of the at least one event includes at least one user rejection indication. In some embodiments, the event includes an eSIM profile download or an RPM procedure for an eSIM profile 208 of the wireless device 608. In some embodiments, the at least one reason for rejection includes at last one unsupported event type identifier indicating the wireless device 608 does not support execution of the at least one event pending for the wireless device 608. In some embodiments, the cancelation message indicating rejection of the at least one event includes one or more event identifier (ID) values for the at least one event. In some embodiments, the cancelation message includes a hash of the one or more event ID values for the at least one event and/or of a reason value for rejection of the at least one event. In some embodiments, the cancelation message includes a digital signature of an eUICC 108 of the wireless device 102.

FIG. 6B illustrates a flow chart 610 of a representative method to manage event records for a wireless device 608 by one or more components of a discovery service server 620, e.g., an SM-DS 310. At 612, the method includes providing, to the wireless device 608, an indication of one or more events pending for the wireless device 608 available an MNO provisioning server 116, from SM-DP+ 308. At 614, the method further includes obtaining, from the wireless device 608, a cancelation message indicating rejection of at least one event of the one or more events and including a reason for rejection of the at least one event. At 616, the method further includes deleting at least one event record associated with the at least one event for the wireless device 608. At 618, the method further includes providing, to the MNO provisioning server 116, e.g., to the SM-DP+ 310, a deletion message indicating deletion of the at least one event record from the discovery service server 620, e.g., from the SM-DS 310, where the deletion message includes the at least one reason for rejection of the at least one event.

In some embodiments, the at least one event includes an eSIM profile 208 download. In some embodiments, the at least one event includes an RPM procedure for an eSIM profile 208 of the wireless device 608. In some embodiments, the at least one event includes an eSIM profile 208 download, and the at least one reason for rejection of the at least one event includes a duplicate identifier indicating the eSIM profile 208 was previously downloaded to the wireless device 608 from the MNO provisioning server 116, e.g., from the SM-DP+ 308. In some embodiments, the at least one reason for rejection of the at least one event includes at least one user rejection indication. In some embodiments, the at least one event includes an eSIM profile 208 download or an RPM procedure for an eSIM profile 208 of the wireless device 608. In some embodiments, the at least one reason for rejection of the at least one event includes at least one unsupported event type identifier indicating the wireless device 608 does not support execution of the at least one event pending for the wireless device 608. In some embodiments, the method further includes, prior to deletion of the at least one event record: i) providing, to the MNO provisioning server 116, a confirmation request message regarding deletion of the at least one event record, and ii) receiving, from the MNO provisioning server 116, a message approving deletion of the at least one event record. In some embodiments, the confirmation request message includes at least a portion of the cancelation message received from the wireless device 102 and/or an identifier of an eUICC 108 of the wireless device 102.

### Representative Exemplary Apparatus

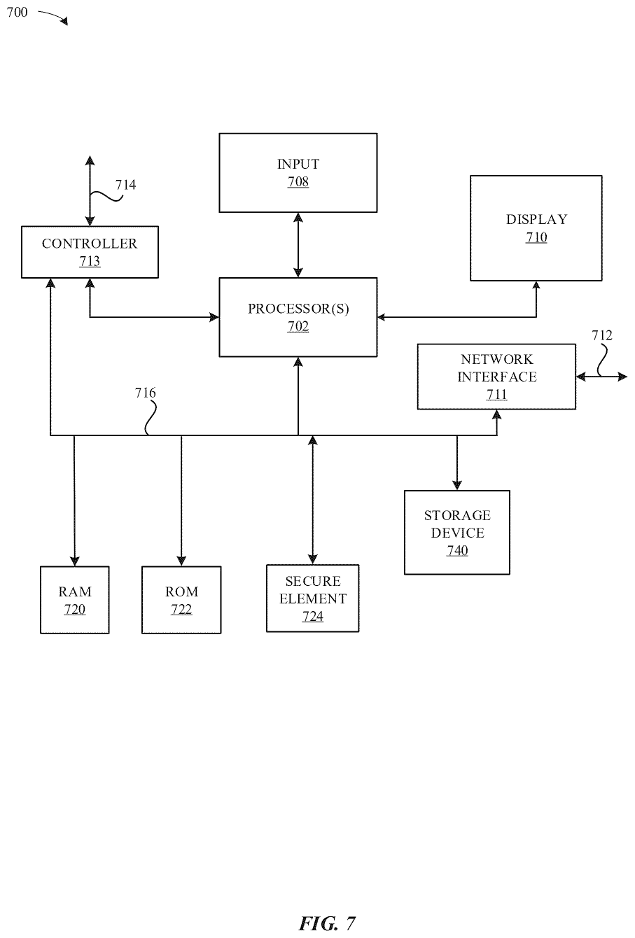

FIG. 7 illustrates in block diagram format an exemplary computing device 700 that can be used to implement the various components and techniques described herein, according to some embodiments. In particular, the detailed view of the exemplary computing device 700 illustrates various components that can be included in a UE 302 or a wireless device 102. As shown in FIG. 7, the computing device 700 can include one or more processors 702 that represent microprocessors or controllers for controlling the overall operation of computing device 700. In some embodiments, the computing device 700 can also include a user input device 708 that allows a user of the computing device 700 to interact with the computing device 700. For example, in some embodiments, the user input device 708 can take a variety of forms, such as a button, keypad, dial, touch screen, audio input interface, visual/image capture input interface, input in the form of sensor data, etc. In some embodiments, the computing device 700 can include a display 710 (screen display) that can be controlled by the processor(s) 702 to display information to the user (for example, information relating to incoming, outgoing, or active communication sessions). A data bus 716 can facilitate data transfer between at least a storage device 740, the processor(s) 702, and a controller 713. The controller 713 can be used to interface with and control different equipment through an equipment control bus 714. The computing device 700 can also include a network/bus interface 711 that couples to a data link 712. In the case of a wireless connection, the network/bus interface 711 can include wireless circuitry, such as a wireless transceiver and/or baseband component. The computing device 700 can also include a secure element 724, which can be configured to store one or more SIM profiles and/or eSIM profiles 208. The secure element 724 can include an eUICC 108, an iUICC, and/or one or more UICCs 118.

The computing device 700 also includes a storage device 740, which can include a single storage or a plurality of storages (e.g., hard drives and/or solid-state drives), and includes a storage management module that manages one or more partitions within the storage device 740. In some embodiments, storage device 740 can include flash memory, semiconductor (solid state) memory or the like. The computing device 700 can also include a Random-Access Memory (RAM) 720 and a Read-Only Memory (ROM) 722. The ROM 722 can store programs, utilities or processes to be executed in a non-volatile manner. The RAM 720 can provide volatile data storage, and stores instructions related to the operation of the computing device 700.

### Wireless Terminology

In accordance with various embodiments described herein, the terms “wireless communication device,” “wireless device,” “mobile device,” “mobile station,” “mobile wireless device,” and “user equipment” (UE) may be used interchangeably herein to describe one or more consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near-field communication (NFC), a cellular wireless network, a fourth generation (4G) LTE, LTE Advanced (LTE-A), 5G, and/or 6G or other present or future developed advanced cellular wireless networks.

The wireless device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless devices that are also capable of communicating via different radio access technologies (RATs). In these scenarios, a multi-mode user equipment (UE) can be configured to prefer attachment to a 5G wireless network offering faster data rate throughput, as compared to other 4G LTE legacy networks offering lower data rate throughputs. For instance, in some implementations, a multi-mode UE may be configured to fall back to a 4G LTE network or a 3G legacy network, e.g., an Evolved High Speed Packet Access (HSPA+) network or a Code Division Multiple Access (CDMA) 2000 Evolution-Data Only (EV-DO) network, when 5G wireless networks are otherwise unavailable.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method to manage event records of a discovery service server by one or more components of a wireless device, the method comprising:
obtaining, from the discovery service server, an indication of one or more events pending for the wireless device available from a mobile network operator (MNO) provisioning server;
determining to reject execution of at least one event of the one or more events pending for the wireless device; and
providing, to the discovery service server, a cancelation message indicating rejection of the at least one event, wherein the cancelation message includes at least one reason for rejection of the at least one event.

2. The method of claim 1, wherein the at least one event comprises an electronic subscriber identity module (eSIM) profile download.

3. The method of claim 1, wherein the at least one event comprises a remote profile management (RPM) procedure for an eSIM profile of the wireless device.

4. The method of claim 1, wherein:
the at least one event comprises an eSIM profile download; and
the reason for rejection of the at least one event comprises a duplicate identifier indicating the eSIM profile was previously downloaded to the wireless device from the MNO provisioning server.

5. The method of claim 1 further comprising:
requesting user consent to the at least one event pending for the wireless device; and
obtaining user rejection of the at least one event,
wherein the reason for rejection of the at least one event comprises at least one user rejection indication.

6. The method of claim 5, wherein the at least one event comprises an eSIM profile download or an RPM procedure for an eSIM profile of the wireless device.

7. The method of claim 1, wherein:
the reason for rejection of the at least one event comprises an unsupported event type identifier indicating the wireless device does not support execution of the at least one event pending for the wireless device.

8. The method of claim 1, wherein:
the cancelation message comprises one or more event identifier (ID) values for the at least one event.

9. The method of claim 8, wherein:
the cancelation message comprises a hash of the one or more event ID values for the at least one event and/or of a reason value for the reason for rejection of the at least one event.

10. The method of claim 1, wherein:
the cancelation message comprises a digital signature of an embedded universal integrated circuit card (eUICC) of the wireless device.

11. A method to manage event records for a wireless device, the method comprising:
by one or more components of a discovery service server:
providing, to the wireless device, an indication of one or more events pending for the wireless device available from a mobile network operation (MNO) provisioning server;
obtaining, from the wireless device, a cancelation message indicating rejection of at least one event of the one or more events and including at least one reason for rejection of the at least one event;
deleting at least one event record associated with the at least one event for the wireless device; and
providing, to the MNO provisioning server, a deletion message indicating deletion of the at least one event record from the discovery service server, wherein the deletion message includes the at least one reason for rejection of the at least one event.

12. The method of claim 11, wherein the at least one event comprises an electronic subscriber identity module (eSIM) profile download.

13. The method of claim 11, wherein the at least one event comprises a remote profile management (RPM) procedure for an eSIM profile of the wireless device.

14. The method of claim 11, wherein:
the at least one event comprises an eSIM profile download; and
the reason for rejection of the at least one event comprises a duplicate identifier indicating the eSIM profile was previously downloaded to the wireless device from the MNO provisioning server.

15. The method of claim 11, wherein the at least one reason for rejection of the at least one event comprises at least one user rejection indication.

16. The method of claim 15, wherein the at least one event comprises an eSIM profile download or an RPM procedure for an eSIM profile of the wireless device.

17. The method of claim 11, wherein:
the reason for rejection of the at least one event comprises at least one unsupported event type identifier indicating the wireless device does not support execution of the at least one event pending for the wireless device.

18. The method of claim 11, further comprising and prior to deletion of the at least one event record:
providing, to the MNO provisioning server, a confirmation request message regarding deletion of the at least one event record; and
receiving, from the MNO provisioning server, a message approving deletion of the at least one event record.

19. The method of claim 18, wherein:
the confirmation request message comprises at least a portion of the cancelation message received from the wireless device and/or an identifier of an embedded universal integrated circuit card (eUICC) of the wireless device.

20. An apparatus comprising one or more processors coupled to a memory storing instructions to configure a wireless device to manage event records of a discovery service server by at least:
obtaining, from the discovery service server, an indication of one or more events pending for the wireless device available from a mobile network operator (MNO) provisioning server;
determining to reject execution of at least one event of the one or more events pending for the wireless device; and
providing, to the discovery service server, a cancelation message indicating rejection of the at least one event, wherein the cancelation message includes at least one reason for rejection of the at least one event.
